(19) United States
(12) Patent Application Publication
(10) Pub. No.: US 2025/0119787 A1
(43) Pub. Date: Apr. 10, 2025

(54) NETWORK-AIDED POWER SAVINGS SYSTEM

(71) Applicant: Verizon Patent and Licensing Inc., Basking Ridge, NJ (US)

(72) Inventors: Lily Zhu, Parsippany, NJ (US); Chokri Trabelsi, Bridgewater, NJ (US); Jeremy Nacer, Boca Raton, FL (US)

(21) Appl. No.: 18/480,583

(22) Filed: Oct. 4, 2023

(51) Int. Cl. H04W 28/02; H04L 43/0852

(52) U.S. Cl. CPC H04W 28/0289; H04L 43/0852; H04W 28/0247

(57) ABSTRACT

A device may include a processor. The processor may be configured to: determine whether a network demand for the device to send or receive data is below a threshold; if the network demand is below threshold, determine whether a network to which the device is wirelessly connected is congested; and when it is determined that the network is not congested, decrease processing capabilities at the device to process the network demand.

### BACKGROUND INFORMATION

Wireless communication service providers continue to develop and expand available services and their networks to meet increasing consumer driven demands for higher bandwidth and lower latency. However, data-intensive applications like augmented reality (AR), cloud gaming, and video conferencing not only require high bandwidths and low latency on the network side but also cause the host devices to consume power at increasing rates.

### BRIEF DESCRIPTION OF THE DRAWINGS

FIG. 1 illustrates concepts described herein.

FIG. 2 illustrates an exemplary network environment in which systems and methods described herein may be implemented.

FIG. 3 depicts example components of a User Equipment device (UE) according to an implementation.

FIG. 4 illustrates example components of an access station according to an implementation.

FIG. 5 illustrates example contents of a Downlink Control Information (DCI) with a Paging-Radio Network Temporary Identifier (P-RNTI) according to different implementations.

FIGS. 6A and 6B depict example fields of Short Messages according to different implementations.

FIG. 7 illustrates an example establishment of Low Latency Low Loss Scalable Throughput (L4S) flows, according to an implementation.

FIG. 8 depicts a portion of an Internet Protocol (IP) header of an IP packet of an L4S flow according to an implementation.

FIG. 9 is a flow diagram of an exemplary process associated with performing network-aided power savings at a User Equipment device (UE).

FIG. 10 is a messaging diagram that is associated with performing network-aided power savings at a UE.

FIG. 11 depicts exemplary functional components of a network device according to an implementation.

### DETAILED DESCRIPTION

The following detailed description refers to the accompanying drawings. The same reference numbers in different drawings may identify the same or similar elements. The description uses terms in the context of a particular technology. For example, as used herein, the term “resource element” may refer to the smallest unit of the resource grid made up of one subcarrier in frequency and one Orthogonal Frequency Division Multiplexing (OFDM) symbol in time domain. A Resource Element Group (REG) may include one resource block (N resource elements in frequency domain) and one OFDM symbol in time domain. A physical channel may include communication pathways that comprise a series of REGs.

Systems and methods described herein relate to saving power at User Equipment devices (UEs) (e.g., smart phones) with the aid from a network. As Fifth Generation (5G) network features continue to evolve, power demands of UEs also increase to support higher computational requirements of the programs running on the UEs. The extent to which the UEs can meet the power demands has a direct impact on the end-to-end customer experience, as battery life (e.g., a length of time until the battery needs to be recharged) shortens with increased device processing. Although UEs can extend their battery life by curtailing battery power expenditure, such savings should not impact the performance and efficiency of the network servicing the UEs.

One issue in saving UE battery power stems from the UE's lack of knowledge of network load. For example, assume that a UE is handling low traffic to/from the network and the low network traffic is due to congestion at the cell. In such a situation, reducing UE processing capabilities (e.g., reduce capabilities for processing Multiple Input Multiple Output (MIMO) layers) can extend the duration of time over which UE data is transmitted to or received from the network-resulting in a drain in battery power. Accordingly, to ensure that reducing its processing capabilities is the best option, the UE needs to distinguish between low traffic due to a low network demand for the UE to receive or send data and low traffic due to a high network load.

Although there are mechanisms to notify the network of the internal status of UEs (e.g., mechanisms within the UE Assistance Information (UAI) domain), such mechanisms may be triggered independent of network load. The systems and methods described herein address the preceding issue, by timely informing UEs of network load/congestion conditions.

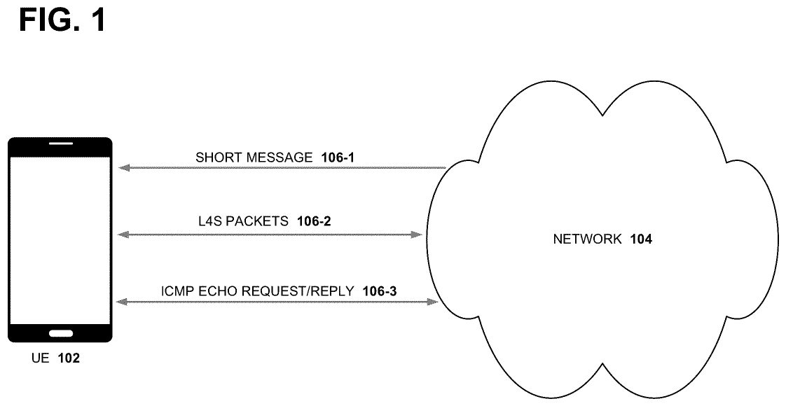

FIG. 1 illustrates the concepts described herein. As shown, UE 102 receives its communication and/or content services from a service provider network 104 (e.g., a cellular network). Assume that UE 102 experiences a low traffic to/from network 104. To aid UE 102 to determine whether the low traffic is due a high network load or due to a low demand for the UE to receive or send data, network 104 implements multiple mechanisms to enable UE 102 to obtain the status of network load from the network. For example, as shown, network 104 may send what is referred to as Short Messages 106-1 that include indications of network congestion. In addition, network 104 may enable UE 102 to establish a Low Latency Low Loss Scalable Throughput (L4S) connection with network 104 and to receive L4S packets (106-2) that provide explicit congestion notifications from network 104. Alternatively, and/or additionally, network 104 may enable UE 102 to send Internet Control Message Protocol (ICMP) echo requests and to receive ICMP replies (106-3). UE 102 may measure the response time to determine whether network 104 is congested. Based on the Short Messages, L4S packets, and ICMP echo requests/replies, UE 102 may determine whether the low traffic is indicative of a low network demand or congestion. If the low traffic is due to a low network demand, UE 102 may reduce its processing capabilities.

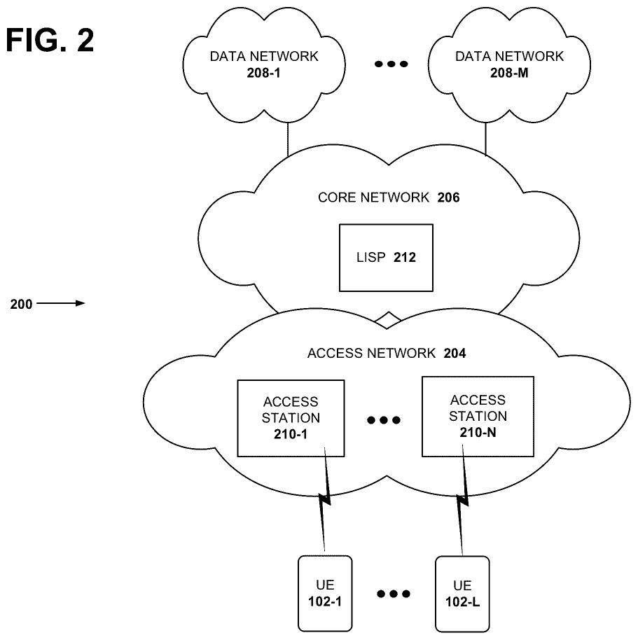

FIG. 2 illustrates an exemplary network environment 200 in which the systems and methods may be implemented. As shown, environment 200 may include UEs 102-1 through 102-L (collectively referred to as UEs 102 and generically referred to as UE 102), an access network 204, a core network 206, and data networks 208-1 through 208-M (collectively referred to as data networks 208 and generically referred to as data network 208). Access network 204, core network 206, and data networks 208 may be part of provider network 104 (not shown in FIG. 2).

UEs 102 may include wireless communication devices capable of 5G New Radio (NR) communication. Some UEs 102 may additionally include Fourth Generation (4G) (e.g., Long-Term Evolution (LTE)) communication capabilities or Sixth Generation (6G) communication capabilities. Examples of UE 102 include: a smart phone; a tablet device; a wearable computer device (e.g., a smart watch); a global positioning system (GPS) device; a media playing device; a portable gaming system; an autonomous vehicle navigation system; a sensor, such as a pressure sensor; a Fixed Wireless Access (FWA) device; a Customer Premises Equipment (CPE) device, with or without Wi-Fi® capabilities; and an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices. As already briefly described with reference to FIG. 1, UE 102 may include one or more components that permit UE 102 to control, at least partly, its processing capabilities with the aid from network 104.

Access network 204 may allow UE 102 to access core network 206. To do so, access network 204 may establish and maintain, with participation from UE 102, an over-the-air channel with UE 102; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210-1 through 210-N (collectively referred to as access stations 210 and generically referred to as access station 210) for establishing and maintaining over-the-air channel with UEs 102. In some implementations, access station 210 may include a 4G, 5G, 6G or another type of base station (e.g., eNB, gNB, etc.) that includes one or more radio frequency (RF) transceivers. In some implementations, access station 210 may be part of an evolved Universal Mobile Telecommunications Service (UMTS) Terrestrial Radio Access Network (eUTRAN). To aid UE 102 in saving battery power, each access station 210 may include one or more components to provide Short Messages to UE 102 and to provide support for L4S communication for UE 102. These are described in greater detail with reference to FIG. 4.

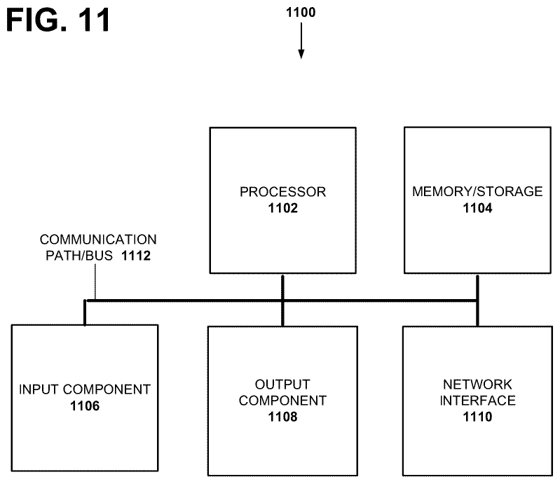

Core network 206 may manage communication sessions of UEs 102 connecting to core network 206 via access network 204. For example, core network 206 may establish an Internet Protocol (IP) connection between UEs 102 and data networks 208. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven server-less architecture interface, and/or another type of SDN component. The common shared physical infrastructure may be implemented using one or more devices 1100 described below with reference to FIG. 11 in a cloud computing center associated with core network 206. Core network 206 may include 5G core network components, 4G core network components, and/or another type of core network components (e.g., 6G core network components).

As further shown, core network 206 may include one or more of L4S Input Service Point (LISP) 212. LISP 212 may serve as an endpoint with which UE 102 can establish an L4S connection so that UE 102 can receive L4S packets that originate from LISP 212 and bear markings provided by access station 210. Additionally, LISP 212 may provide an endpoint to which UE 102 can send ICMP echo requests, to determine network load/congestion. Multiple instances of LISP 212 may be implemented on portions of network 104 other than core network 206, such as access network 204 or data networks 208. Each LISP 212 may respond to an ICMP echo request with ICMP echo replies with delay indicators. The delay indicators may indicate congestion conditions at different portions of network 104.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, an LTE network), a telephone network (e.g., the Public Switched Telephone Network (PSTN) or a cellular network), an intranet, or a combination of networks. Data network 208 may include an application server (also referred to as application). An application may provide services for a program or an application running on UE 102 and may establish communication sessions with UE 102 via core network 206.

For clarity, FIG. 2 does not show all components that may be included in network environment 200 (e.g., routers, bridges, wireless access point, additional networks, data centers, portals, etc.). Depending on the implementation, network environment 200 may include additional, fewer, different, or a different arrangement of components than those illustrated in FIG. 2. Furthermore, in different implementations, the configuration of network environment 200 may be different.

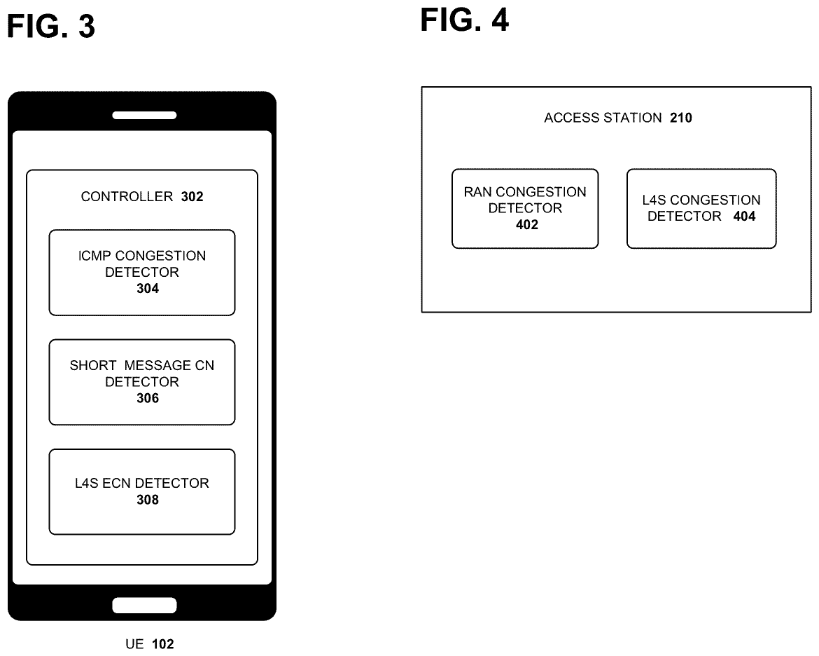

FIG. 3 depicts example components of UE 102 according to an implementation. As shown, UE 102 may comprise a controller 302, which in turn may include an ICMP congestion detector 304, a Short Message Congestion Notification (CN) detector 306, and a L4S Explicit Congestion Notification (ECN) detector 308. Although not shown, UE 102 and/or controller 302 may include additional components. Furthermore, depending on the implementation, controller 302 may include additional, fewer, or different components than those illustrated.

Controller 302 may increase or decrease processing capabilities on UE 102. In some implementations, controller 302 may reduce capabilities for processing based on network demand for UE 102 to provide or receive data. More specifically, when controller 302 detects a low traffic demand from network 104, controller 302 may determine whether network 104 is congested based on output from ICMP congestion detector 304, Short Message CN detector 306, and/or L4S ECN detector 308. If controller 302 determines that the network is not congested, controller 302 may reduce processing capabilities for meeting the network demand, hence aiding in extending battery life.

ICMP congestion detector 304 may determine whether network 104 or portions of network 104 are congested, by sending ICMP echo requests to one or more of instances of LISP 212 and receiving ICMP replies from the LISP 212 instances. After determining the Round-Trip Time (RTT) for the ICMP echo request-replies, ICMP congestion detector 304 may compare the determined RTTs to corresponding thresholds. If an RTT exceeds the corresponding threshold, the traffic at the LISP 212 instance may be congested. ICMP congestion detector 304 may then indicate to controller 302 whether it has detected a congestion in network 104.

Short Message CN detector 306 may scan (or cause a modem in UE 102 to scan) a Physical Downlink Control Channel (PDCCH) for Downlink Control Information (DCI) format 1_0 (referred to herein as “DCI 1_0”) that is encoded with a Paging-Radio Network Temporary Identifier (P-RNTI). When Short Message CN detector 306 detects Short Messages in the DCI with the P-RNTI, Short Message CN detector 306 may examine one or more bits of the Short Messages. Short Message CN detector 306 may inform controller 302 whether the bits of the Short Messages indicate a network congestion.

L4S ECN detector 308 may initiate an L4S connection with an endpoint (e.g., LISP 212) in network 104. When L4S ECN detector 308 receives packets which were sent by LISP 212 over the connection, L4S ECN detector 308 may determine whether the packets have been marked by access station 210. Based on the markings, L4S ECN detector 308 determine whether the access station 210 or access network 204 is congested and may convey the congestion status of network 104 to controller 302.

FIG. 4 illustrates example components of access station 210 according to an implementation. As shown, access station 210 may include a Radio Access Network (RAN) congestion detector 402 and a L4S congestion detector 404. Although access station 210 may include additional components, they are not illustrated in FIG. 4 for clarity.

RAN congestion detector 402 may determine whether access station 210 and/or access network 204 in which access station 210 is hosted is congested based on the aggregate throughput for a given traffic class and/or a spectrum. If RAN congestion detector 402 determines that access station 210/access network 204 is congested, RAN congestion detector 402 may generate a DCI 1_0 encoded with the P-RNTI. The DCI 1_0 with the P-RNTI may include Short Messages which indicate that access station 210/access network 204 is congested.

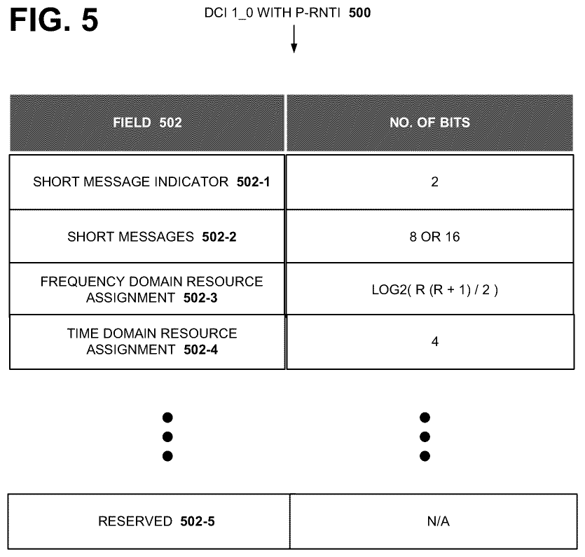

FIG. 5 illustrates example contents of a DCI 1_0 with the P-RNTI 500 according to different implementations. As shown, DCI 1_0 with the P-RNTI 500 may include a Short Message indicator field 502-1, Short Messages 502-2, a frequency domain resource assignment field 502-3, a time domain resource assignment field 502-4, and a reserved field 502-5. Although DCI 1_0 with the P-RNTI 500 includes other fields, they are not shown for clarity.

Short Message indicator field 502-1 may indicate whether Short Messages 502-2 convey a System Information (SI) modification, a Public Warning System (PWS) notification, or a paging signal. The bit values of 10 in field 502-1 may indicate that only Short Messages are present in DCI 1_0 with the P-RNTI 500 and the bit values of 11 may indicate that both paging information and Short Messages are present in DCI 1_0 with the P-RNTI 500. For the implementations described herein, the bit values of field 502-1 may be set at 11 or 10.

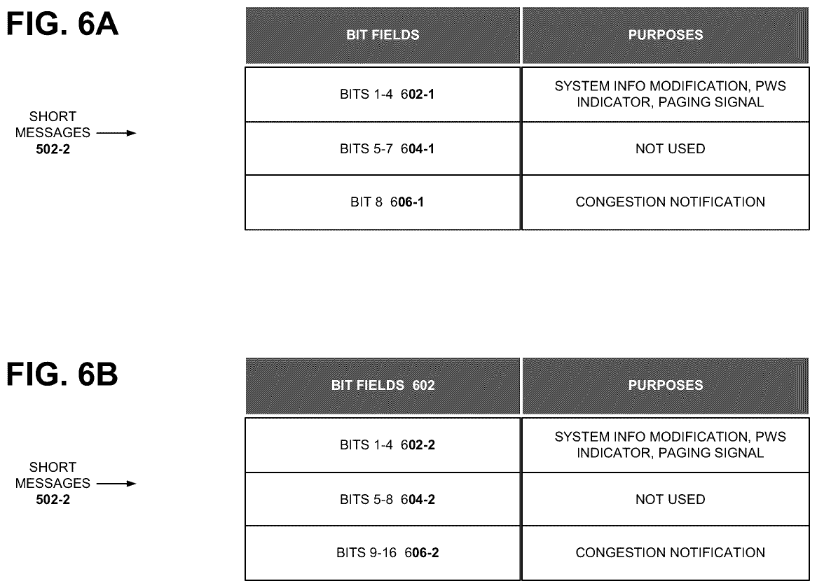

Short Messages 502-2 may include various types of information, one of which includes a congestion notification. Short Message 502-2 is described below further with reference to FIGS. 6A and 6B. According to some implementations, Short Message 502-2 may include 8 bits. In other implementations, Short Message 502-2 may include 16 bits.

Frequency domain resource assignment field 502-3 may indicate the number of bits required to represent the number of resource blocks that occupy the bandwidth associated with UE 102. Time domain resource assignment field 502-4 may include R bits (e.g., R=4, 8, etc.) and may identify a row, in a Physical Downlink Shared Channel (PDSCH), that includes Paging information when Short Message indicator field 502-1 is set to 11. If Short Message indicator field 502-1 is set to 10, time resource assignment field 502-4 is reserved. Reserved field 502-5 may include bits reserved for future use.

FIGS. 6A and 6B depict example fields of Short Messages 502-2, according to different implementations. FIG. 6A illustrates fields of Short Messages 502-2 when Short Messages 502-2 are implemented to be 1 byte long, and FIG. 6B illustrates fields of Short Messages 502-2 when Short Messages 502-2 are implemented to be 2-bytes long. As shown, bits 1-4 602-1 in FIG. 6A and bits 1-4 602-2 in FIG. 6B may include indications of system information modification, PWS notifications, or a paging signal. Bits 5-7 604-1 in FIG. 6A and bits 5-8 604-2 in FIG. 6B are not used. However, in FIG. 6A, bit 8 606-1 is used to indicate the network congestion condition, whereas in FIG. 6B, bits 9-16 are used to indicate the network congestion condition. In other implementations, Short Messages 502-2 may include additional, fewer, or different bits than those illustrated in FIGS. 6A and 6B.

Returning to FIG. 4, when RAN congestion detector 402 determines that access station 210/access network 204 is congested, RAN congestion detector 402 may generate DCI 1_0 with the P-RNTI 500, setting Short Message indicator field 502-1 to either 10 or 11 and filling Short Messages 502-2 with a bit 8 value or bits 9-16 values that indicate the congestion state of network 104. Next, RAN congestion detector 402 may send DCI 1_0 with the P-RNTI 500 over a PDCCH. UE 102 may monitor Short Messages 502-2 with paging in Radio Resource Control (RRC) IDLE state, RRC_INACTIVE state, and/or RRC_CONNECTED state.

L4S congestion detector 404 may manage L4S connections between UE 102 and an L4S endpoint (e.g., LISP 212). More specifically, L4S congestion detector 404 may monitor L4S connections that are set up between UEs 102 and L4S endpoints (LISPs 212). In addition, L4S congestion detector 404 may monitor L4S traffic from LISP 212 passing through access station 210. When L4S congestion detector 404 determines that access station 210/access network 204 Is congested, L4S congestion detector 404 may locate the L4S flow from the L4S endpoint to UE 102 and mark what are referred to as Explicit Congestion Notification (ECN) bits in the Type of Service (TOS) field (also referred to as Traffic Class field) in the IP header of the packets.

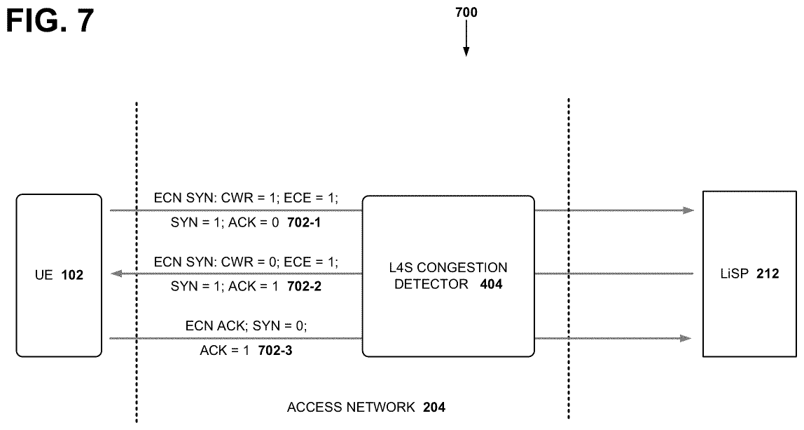

FIG. 7 illustrates an example of establishing L4S flows according to an implementation. In FIG. 7, when L4S ECN detector 308 (not shown in FIG. 7) receives a request from controller 302 (also not shown) in UE 102 to determine whether access station 210 or access network 204 is congested, L4S ECN detector 308 may request UE 102 to connect to LISP 212 in network 104. In response, network 104 may establish a PDU session between UE 102 and a gateway to LISP 212 and set up a L4S flow between L4S ECN detector 308 and LISP 212. Assuming that Transmission Control Protocol (TCP) is in effect, L4S ECN detector 308 may send an ECN Synchronization packet (SYN) 702-1 to LISP 212, with the Congestion Window Reduced (CWR) bit, the ECN echo (ECE) bit, and the SYN flag in its TCP header all set to 1. LISP 212 is L4S capable and hence, in response, may forward to UE 102 an ECN SYN/ACK reply 702-2, with the CWR bit and the ECE bit of the TCP header set to 0 and 1, respectively. The SYN and ACK flags of the reply 702-2 may be set to 1 and 1, respectively. The ECN bits of reply 702-2 may indicate that LISP 212 supports the L4S functionality. ECN SYN/ACK 702-2 may indicate that LISP 212 accepts the request to set up the L4S flow. Next, UE 102 may respond to ECN SYN/ACK 702-2, by transmitting ECN ACK 702-3 to LISP 212, with the SYN and ACK flags set to 0 and 1.

In FIG. 7, L4S congestion detector 404 may monitor access station 210 for any L4S flows from UE 102 to network endpoints. When L4S congestion detector 404 notices the L4S flow from UE 102 to LISP 212, L4S congestion detector 404 may register the flow and monitor any flow in the reverse direction, from the endpoint (i.e., LISP 212) in network 104 to UE 102. When L4S congestion detector 404 detects congestion at access station 210 and/or access network 204, L4S congestion detector 404 may mark the underlying IP packets of the flow from LISP 212 to UE 102. The marking may set the ECN bits of the IP packets to indicate the congestion condition at access station 210 or access network 204. When L4S ECN detector 308 at UE 102 receives the L4S packets, L4S ECN detector 308 may determine whether network 104 (i.e., access network 204 or access station 210) is congested by examining the ECN bits of the IP packets (i.e., determine whether the ECN bits have been set by L4S congestion detector 404 to indicate a congestion condition at access station 210/access network 204). Depending on the ECN bit values, L4S ECN detector 308 may notify controller 302 whether access station 210/access network 204 is congested.

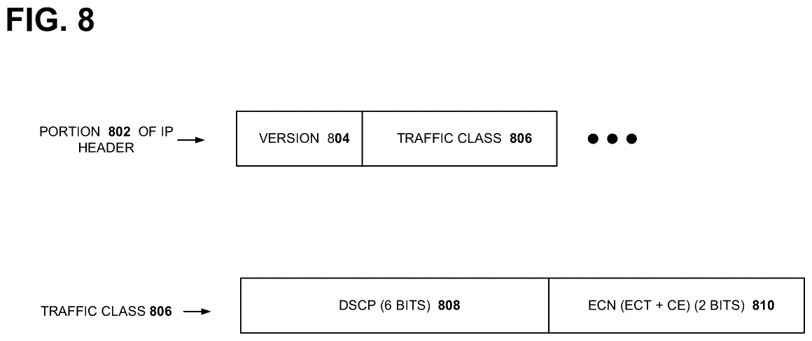

FIG. 8 depicts a portion 802 of an IP header of an IP packet of an L4S flow according to an implementation. As shown, portion 802 of an IP header (either IPv6 or IPv4) may include a version field 804 and a traffic class field 806 (also referred to as Type of Service (TOS) field 806). As further shown, TOS field 806 may include a Differentiated Service Class Codepoint (DSCP) 808 and ECN 810. DSCP 808 may include 6 bits and may indicate a class to which the IP packet belongs for receiving a particular level of service. ECN 810 may include 2 bits, an ECN Capable Transport (ECT) bit and a Congestion Experienced (CE) bit. Returning to FIG. 4, L4S congestion detector 404 may set the CE bit of the IP header of the IP packet of the L4S flow, from LISP 212 to UE 102, to 1 when L4S congestion detector 404 determines that access station 210/access network 204 is congested.

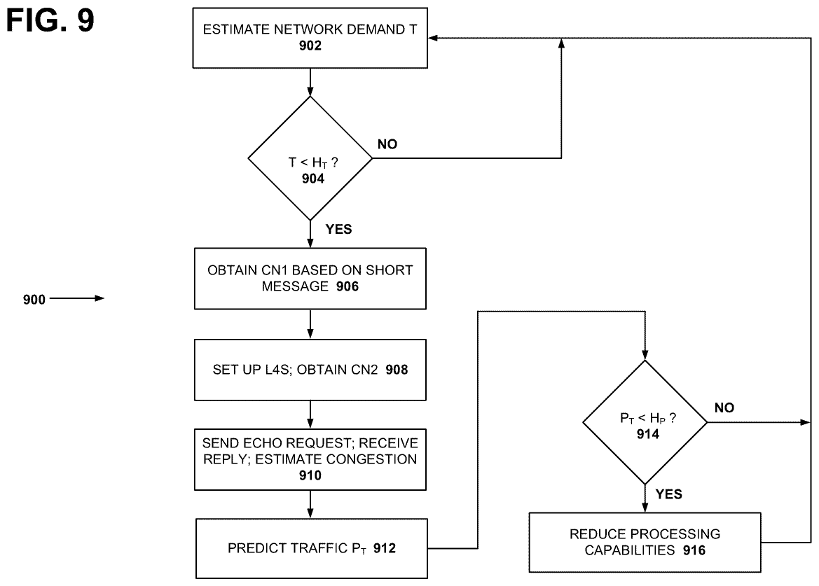

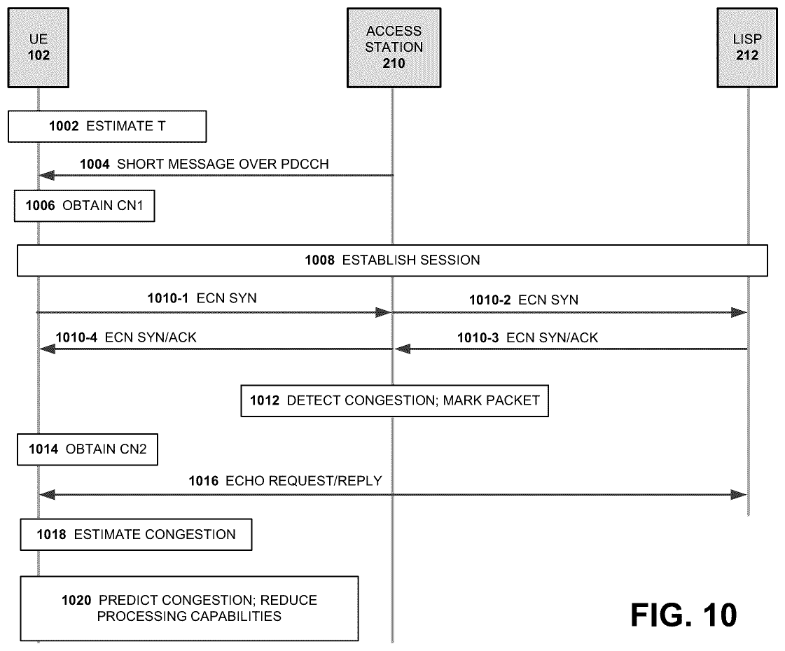

FIG. 9 is a flow diagram of an exemplary process 900 for performing network-aided power savings at UE 102. Process 900 may be performed by UE 102, access station 210, LISP 212, and/or other components in network 104 (e.g., a router). FIG. 10 is a messaging diagram that is associated with process 900. FIG. 10 is described in connection with process 900. As shown, process 900 may include UE 102 estimating a future network demand for UE traffic (e.g., demand to receive UE data or to transmit data to UE 102) (block 902; block 1002). For example, UE 102 may estimate the demand based on t, the current rate of data transmission to network 104 and/or the current rate of data received from network 104. Next, UE 102 may determine whether the estimated demand T is lower than a threshold H_{T} (block 904). If the estimated demand T is not below the threshold H_{T} (block 904: NO), process 900 may return to block 902, to continue estimating the future network demands. If the estimated demand T is below the threshold H_{T} (block 904: YES), UE 102 may obtain a congestion notification CN1 based on recently received Short Messages (arrow 1004) over a PDCCH in DCI 1_0 using the P-RNTI 500 from access station 210 (block 906; block 1006). If access station 210 has not recently sent Short Messages, CN1 may be set to 0, indicating no congestion notification.

Process 900 may further include UE 102 setting up an L4S session and/or flow between UE 102 and a network endpoint, such as LISP 212 (block 908; block 1008; arrows 1010-1, 1010-2, 1010-3, and 1010-4). Once the L4S connection through access station 210 is set up, access station 210 may detect congestion at access station 210 and mark any L4S packets from LISP 212 to UE 102 (block 1012). When UE 102 receives L4S packets from LISP 212, UE 102 may determine whether the underlying IP packets have been marked by access station 210. For example, L4S ECN detector 308 may determine whether the CE flag of ECN field 810 has been set to 1 by L4S congestion detector 404 at access station 210. Based on the markings on the underlying IP packets, UE 102 may obtain another congestion notification CN2 (block 908; block 1014).

Process 900 may further include UE 102 sending an ICMP echo request to a network endpoint (e.g., LISP 212) (block 910; arrow 1016). When UE 102 receives an ICMP echo reply from the endpoint (arrow 1016), UE 102 may calculate the RTT based on the timestamp indicated in the payload of the ICMP echo reply. Furthermore, based on the RTT, UE 102 may determine the level of network congestion (e.g., whether network 104 is experiencing congestion) (block 910; block 1018).

After obtaining CN1, CN2, and/or the estimated congestion at network 104, UE 102 may estimate a likelihood of network traffic congestion P_{T} (block 912: block 1020) based on CN1, CN2, and/or the estimated congestion at network 104. To estimate the likelihood of network traffic congestion P_{T}, for example, UE 102 may obtain a weighted average of CN1, CN2, and/or the estimated network congestion.

After UE 102 determines P_{T}, UE 102 may determine whether the likelihood of congestion P_{T} is below a threshold H_{P} (block 914). It the likelihood of congestion P_{T} is indeed below H_{P} (block 914: YES), UE 102 may conclude that the estimated traffic T at UE 102 is low due to a low network demand and not due to a network congestion. Accordingly, UE 102 may reduce its processing capabilities associated with meeting the network demand (e.g., reduce processing capabilities associated with processing MIMO layers) (block 916; block 1020) and return to block 902. On the other hand, if UE 102 determines that the likelihood of congestion P_{T} is not below the threshold H_{P} (block 914: NO), UE 102 may conclude that the low traffic is due to a network congestion and return to block 902.

FIG. 11 depicts exemplary components of an exemplary network device 1100.

Network device 1100 may correspond to or be included in any of the devices and/or components illustrated in FIGS. 1-4, 7, and 10 (e.g., UE 102, access network 204, core network 206, data network 208, access station 210, LISP 212, etc.). In some implementations, network devices 1100 may be part of a hardware network layer on top of which other network layers and network functions (NFs) may be implemented.

As shown, network device 1100 may include a processor 1102, memory/storage 1104, input component 1106, output component 1108, network interface 1110, and communication path 1112. In different implementations, network device 1100 may include additional, fewer, different, or different arrangement of components than the ones illustrated in FIG. 11. For example, network device 1100 may include line cards, switch fabrics, modems, etc.

Processor 1102 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1100 and/or executing programs/instructions.

Memory/storage 1104 may include static memory, such as read only memory (ROM), and/or dynamic memory, such as random access memory (RAM), or onboard cache, for storing data and machine-readable instructions (e.g., programs, scripts, etc.). Memory/storage 1104 may also include an optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1104 may be external to and/or removable from network device 1100. Memory/storage 1104 may include, for example, a Universal Serial Bus (USB) memory stick, a dongle, a hard disk, off-line storage, a Blu-Ray® disk (BD), etc. Memory/storage 1104 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1106 and output component 1108 may provide input and output from/to a user to/from network device 1100. Input/output components 1106 and 1108 may include a display screen, a keyboard, a mouse, a speaker, a microphone, a camera, a DVD reader, USB lines, and/or other types of components for obtaining, from physical events or phenomena, to and/or from signals that pertain to network device 1100.

Network interface 1110 may include a transceiver (e.g., a transmitter and a receiver) for network device 1100 to communicate with other devices and/or systems. For example, via network interface 1110, network device 1100 may communicate over a network, such as the Internet, an intranet, cellular, a terrestrial wireless network, a satellite-based network, optical network, etc. Network interface 1110 may include a modem, an Ethernet interface to a LAN, and/or an interface/connection for connecting network device 1100 to other devices.

Communication path or bus 1112 may provide an interface through which components of network device 1100 can communicate with one another.

Network device 1100 may perform the operations described herein in response to processor 1102 executing software instructions stored in a non-transient computer-readable medium, such as memory/storage 1104. The software instructions may be read into memory/storage 1104 from another computer-readable medium or from another device via network interface 1110. The software instructions stored in memory/storage 1104, when executed by processor 1102, may cause processor 1102 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense. For example, in the above, while a series of actions, messages, and/or signals, have been described with reference to FIGS. 9 and 10, the order of the actions, messages, signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

Additionally, in this specification, various terms have been used in in the context of particular technologies. For example, as used herein, the term “session” may refer to a series of communications, of a limited duration, between two endpoints (e.g., two applications). When a session is said to be established between an application and a network, the session is established between the application and another application on the network. Similarly, if a session is said to be established between a device and a network, the session is established between an application on the device and another application on the network.

In another example, as used herein, the term “PDU session” may refer to communications between a mobile device and another endpoint (e.g., a data network, etc.). Depending on the context, the term “session” may refer to a session between applications or a PDU session. Additionally, depending on the context, the term “connection” may refer to a session, a PDU session, or another type of connection (e.g., a radio frequency link between a device and a base station).

Further, certain portions of the implementations have been described as “logic” that performs one or more functions. This logic may include hardware, such as a processor, a microprocessor, an application specific integrated circuit, or a field programmable gate array, software, or a combination of hardware and software.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. A wireless device comprising:
a processor configured to:
determine whether a network demand for the device to send or receive data is below a threshold;
if the network demand is below the threshold, determine whether a network to which the device is wirelessly connected is congested; and
when it is determined that the network is not congested, decrease processing capabilities at the device to process the network demand.

2. The wireless device of claim 1, wherein when determining whether the network is congested, the processor is configured to at least one of:
determine a round-trip time to an endpoint in the network;
determine whether an Internet Protocol (IP) header of a Low Latency Low Loss Scalable Throughput (L4S) packet, received from the endpoint, includes an Explicit Congestion Notification (ECN); or
determine whether Short Messages included in a Downlink Control Information (DCI) comprise a congestion notification.

3. The wireless device of claim 2, wherein when determining the round-trip time, the processor is configured to:
send an Internet Control Message Protocol (ICMP) echo request to the endpoint in the network; and
receive an ICMP echo request from the endpoint.

4. The wireless device of claim 2, wherein when determining whether the Short Messages comprise a congestion notification, the processor is configured to:
determine whether the last bit of the Short Messages indicates a network congestion; or
determine whether other bits of the Short Messages indicate a network congestion.

5. The wireless device of claim 1, wherein when decreasing processing capabilities, the processor is configured to:
reduce processing capabilities for processing Multiple Input Multiple Output (MIMO) layers.

6. The wireless device of claim 1, wherein when the device is in a Radio Resource Control (RRC) CONNECTED state and when determining whether the Short Messages comprise a congestion notification, the processor is configured to:
detect the Downlink Control Information (DCI) in a Physical Downlink Control Channel (PDCCH).

7. The wireless device of claim 1, wherein the processor is further configured to:
establish a Low Latency Low Loss Scalable Throughput (L4S) session between the device and an endpoint in the network.

8. A method comprising:
determining whether a network demand for a device to send or receive data is below a threshold;
if the network demand is below the threshold, determining whether a network to which the device is wirelessly connected is congested; and
when it is determined that the network is not congested, decreasing processing capabilities at the device to process the network demand.

9. The method of claim 8, wherein determining whether the network is congested comprises at least one of:
determining a round-trip time to an endpoint in the network;
determining whether an Internet Protocol (IP) header of a Low Latency Low Loss Scalable Throughput (L4S) packets, received from the endpoint, includes an Explicit Congestion Notification (ECN); or
determining whether Short Messages included in a Downlink Control Information (DCI) comprise a congestion notification.

10. The method of claim 9, wherein determining the round-trip time includes:
sending an Internet Control Message Protocol (ICMP) echo request to the endpoint in the network; and
receiving an ICMP echo request from the endpoint.

11. The method of claim 9, wherein determining whether the Short Messages comprise a congestion notification includes:
determining whether the last bit of the Short Messages indicates a network congestion; or
determining whether other bits of the Short Messages indicate a network congestion.

12. The method of claim 9, wherein decreasing processing capabilities includes:
reducing processing capabilities for processing Multiple Input Multiple Output (MIMO) layers.

13. The method of claim 8, wherein when the device is in a Radio Resource Control (RRC) CONNECTED state, determining whether the Short Messages comprise a congestion notification includes:
detecting the Downlink Control Information (DCI) in a Physical Downlink Control Channel (PDCCH).

14. The method of claim 8, further comprising:
establishing a Low Latency Low Loss Scalable Throughput (L4S) session between the device and an endpoint in the network.

15. A non-transitory computer-readable medium comprising processor-executable instructions, which when executed by a processor in a device, cause the processor to:
determine whether a network demand for the device to send or receive data is below a threshold;
if the network demand is below the threshold, determine whether a network to which the device is wirelessly connected is congested; and
when it is determined that the network is not congested, decrease processing capabilities at the device to process the network demand.

16. The non-transitory computer-readable medium of claim 15, wherein when determining whether the network is congested, the processor is further configured to at least one of:
determine a round-trip time to an endpoint in the network;
determine whether an Internet Protocol (IP) header of a Low Latency Low Loss Scalable Throughput (L4S) packets, received from the endpoint, includes an Explicit Congestion Notification (ECN); or
determine whether Short Messages included in a Downlink Control Information (DCI) comprise a congestion notification.

17. The non-transitory computer-readable medium of claim 16, wherein when determining the round-trip time, the processor is configured to:
send an Internet Control Message Protocol (ICMP) echo request to the endpoint in the network; and
receive an ICMP echo request from the endpoint.

18. The non-transitory computer-readable medium of claim 16, wherein when determining whether the Short Messages comprise a congestion notification includes, the processor is configured to:
determine whether the last bit of the Short Messages indicates a network congestion; or
determine whether other bits of the Short Messages indicate a network congestion.

19. The non-transitory computer-readable medium of claim 15, wherein when decreasing processing capabilities, the processor is configured to:
reduce processing capabilities for processing Multiple Input Multiple Output (MIMO) layers.

20. The non-transitory computer-readable medium of claim 15, wherein when the device is in a Radio Resource Control (RRC) CONNECTED state and when determining whether the Short Messages comprise a congestion notification e, processor is configured to:
detect the Downlink Control Information (DCI) in a Physical Downlink Control Channel (PDCCH).
